(19) United States
(12) Patent Application Publication
(10) Pub. No.: US 2016/0075358 A1
(43) Pub. Date: Mar. 17, 2016

(54) Auxiliary Grip of Collapsible Trolley

(71) Applicants: Howard Simon, Los Angeles (CA); Wen Tung Chang, Yilan County (TW)

(72) Inventors: Howard Simon, Los Angeles, CA (US); Wen Tung Chang, Yilan County (TW)

(21) Appl. No.: 14/486,647

(22) Filed: Sep. 15, 2014

(51) Int. Cl. B62B 1/04

(52) U.S. Cl. CPC B62B 1/042

(57) ABSTRACT

A collapsible trolley includes a frame, a carrier plate, two wheel units, a primary grip and two auxiliary grip units. The frame includes two lower tubes and two upper tubes each pivotally connected to a corresponding one of the lower tubes. The carrier plate is connected to the lower tubes. Each of the wheel units is connected to a corresponding one of the lower tubes. The primary grip is supported on the upper tubes. Each of the auxiliary grip units is pivotally connected to a corresponding one of the upper tubes.

### BACKGROUND OF INVENTION

1. FIELD OF INVENTION

The present invention relates to a collapsible trolley and, more particularly, to an auxiliary grip of a collapsible trolley.

2. RELATED PRIOR ART

A conventional trolley includes a frame, a carrier plate non-movably supported on the frame and two wheels connected to the frame. Cargo is put on the carrier plate and against the frame. The carrier plate is lifted from the ground or a floor. The wheels are laid on the ground or floor and ready to roll. The cargo can smoothly be moved around on the ground or floor via the trolley. After the cargo is downloaded from the trolley, the carrier plate is lowered onto the ground or floor and placed substantially horizontally so that the frame is placed substantially vertically. At this moment, the trolley becomes an obstacle and gets in the way of a worker. The worker might hit the trolley and get hurt. The worker might even cause the trolley to move and bump into another worker or another piece of property.

To overcome the foregoing problems, various collapsible trolleys have been devised. As disclosed in Taiwanese Patent M318556, a collapsible trolley includes a frame 10, two wheels 20 and a carrier plate 30. The frame 10 includes a crossbar 11 for interconnecting two telescopic units each including two tubes 12 and 13. The telescopic units can be extended and shrunk. Each wheel 20 is pivotally connected to a corresponding tube 13. The carrier plate 30 is pivotally connected to the tubes 13. The wheels 20 are connected to the carrier plate 30 so that pivoting of the carrier plate 30 about a horizontal axis causes pivoting of each wheel 20 about a vertical axis. However, the pivoting of the carrier plate 30 is not smooth.

To overcome the foregoing problem, the present applicant has applied for and been issued U.S. Pat. No. 8,602,444 for a collapsible trolley that includes a frame 20, a chassis 30, a carrier plate 40 and two wheel units 50. The frame 20 includes a handlebar 25 for interconnecting two telescopic units each including a lower tube 22 and an upper tube 24. The lower tube 22 of each telescopic unit is connected to the chassis 30 via a corresponding link 23. The carrier plate 40 and the wheel assemblies 50 are pivotally connected to the chassis 30. The carrier plate 40 is connected to the wheel units 50 so that pivoting of the carrier plate 40 about a horizontal axis causes pivoting of each wheel assemblies 50 about a vertical axis. The pivoting of the carrier plate 40 is smooth. However, the handling of the handlebar 25 is not convenient.

The present invention is therefore intended to obviate or at least alleviate the problems encountered in prior art.

### SUMMARY OF INVENTION

It is the primary objective of the present invention to provide a convenient collapsible trolley.

To achieve the foregoing objective, the collapsible trolley includes a frame, a carrier plate, two wheel units, a primary grip and two auxiliary grip units. The frame includes two lower tubes and two upper tubes each pivotally connected to a corresponding one of the lower tubes. The carrier plate is connected to the lower tubes. Each of the wheel units is connected to a corresponding one of the lower tubes. The primary grip is supported on the upper tubes. Each of the auxiliary grip units is pivotally connected to a corresponding one of the upper tubes.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a collapsible trolley with two auxiliary grip units according to the preferred embodiment of the present invention;

FIG. 2 is a perspective view of the collapsible trolley in another position than the position shown in FIG. 1;

FIG. 3 is an exploded view of the auxiliary grip units shown in FIG. 1;

FIG. 4 is a perspective view of the auxiliary grip units shown in FIG. 1;

FIG. 5 is a cross-sectional view of one of the auxiliary grip units shown in FIG. 1; and

FIG. 6 is another cross-sectional view of the auxiliary grip unit illustrated in FIG. 5.

### DETAILED DESCRIPTION OF PREFERRED EMBODIMENT

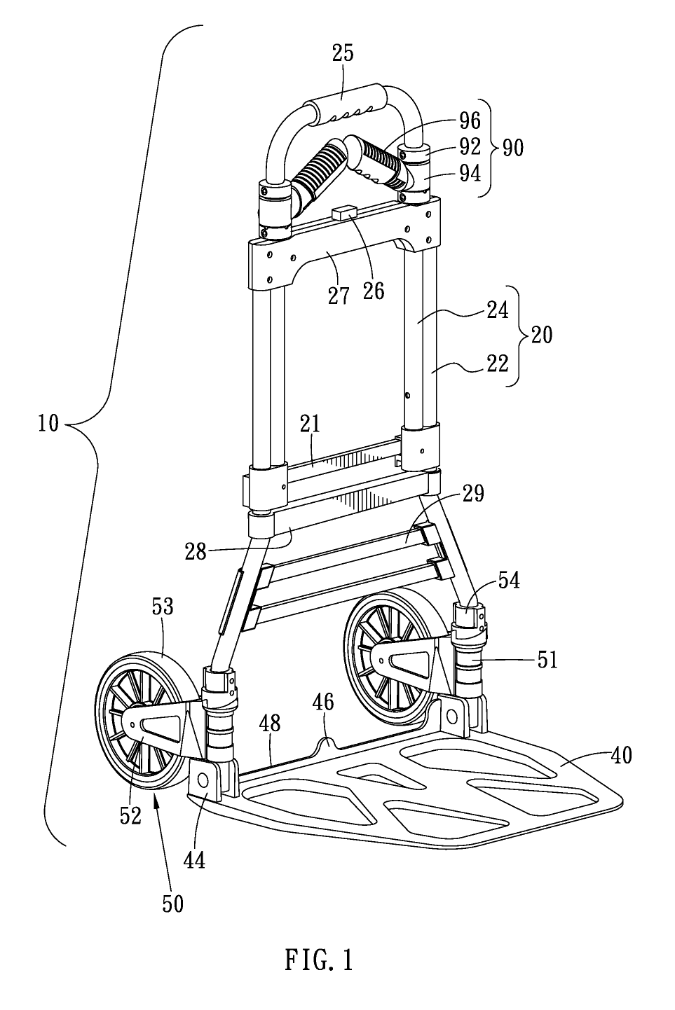

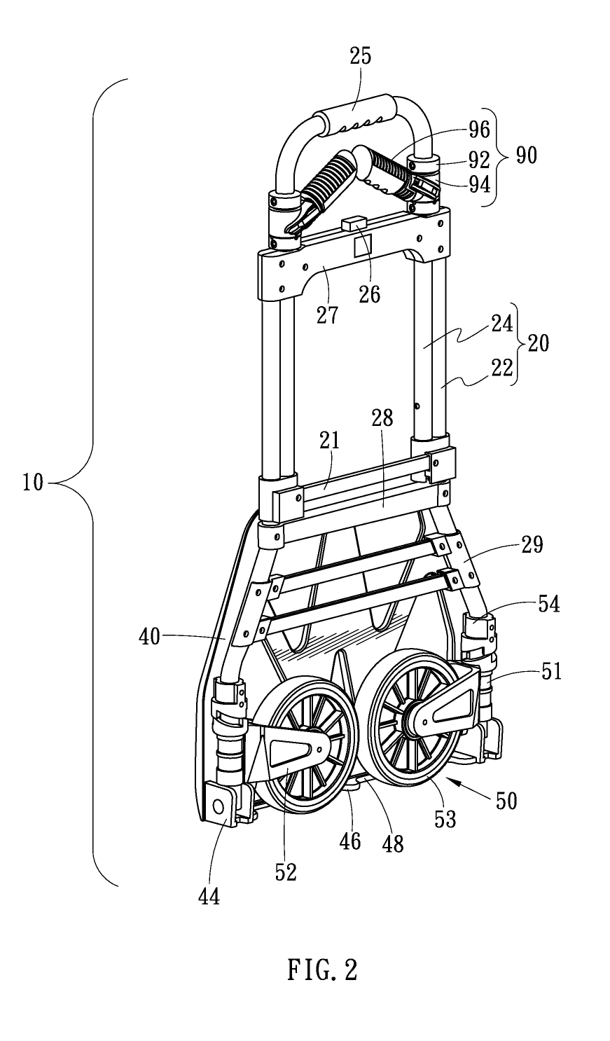

Referring to FIGS. 1 and 2, there is a collapsible trolley 10 according to the preferred embodiment of the present invention. The collapsible trolley 10 includes a frame 20, a carrier plate 40, two wheel units 50 and two auxiliary grip units 90. The carrier plate 40, the wheel units 50 and the auxiliary grip units 90 are pivotally connected to the frame 20. The carrier plate 40 is connected to the wheel units 50 so that pivoting of the carrier plate 40 about a horizontal axis causes pivoting of each wheel unit 50 about a vertical axis.

The frame 20 includes two tubes 22 and two tubes 24. Each tube 22 is formed with an upper section, a lower section and a middle section. The upper section of each tube 22 extends parallel to the upper section of the other tube 22. The lower section of each tube 22 extends parallel to the upper section of the other tube 22. The middle section of each tube 22 extends further from the middle section of the other tube 22 as it extends to the lower section from the upper section.

Two crossbars 29 are used to interconnect the middle sections of the tubes 22. Another crossbar 28 is used to interconnect the upper sections of the tubes 22. The crossbar 28 is located close to the crossbars 29. Another crossbar 27 is used to interconnect the upper sections of the tubes 22. The crossbar 27 is located far from the crossbars 29.

Each tube 24 is formed with a lower end and an upper end. A grip 25 is supported on a transverse tube (not numbered) that is used to interconnect the upper ends of the tubes 24. Preferably, the transverse tube and the tubes 24 are made one. The lower end of each tube 24 is movably connected to the upper section of a corresponding tube 22 by a connector (not numbered). Each of the connectors includes two sleeves. The first sleeve of each of the connectors is connected to the lower end of the corresponding tube 24 so that they are movable together. The second sleeve of each of the connectors is movably supported on the upper section of the corresponding tube 22. Thus, the tubes 24 are movable along the upper sections of the tubes 22. A crossbar 21 is used to connect the first sleeve of one of the connectors to the first sleeve of the other connector.

A button 26 is supported on the crossbar 27. The button 26 is operable to switch a locking unit (not shown) between a locking position and a releasing position. In the locking position, the locking unit locks the tubes 24 in position relative to the tubes 22. In the releasing position, the locking unit allows the tubes 24 to translate relative to the tubes 22. Details of such a locking unit can be found in U.S. Pat. No. 8,602,444 and will not be given hereinafter.

The carrier plate 40 is formed with two pairs of lugs 44, a tab 46 and two cutouts 48. The tab 46 is located between the cutouts 48. Each cutout 48 is located between a corresponding pair of lugs 44 and the tab 46. Each pair of lugs 44 is pivotally connected to the lower section of a corresponding tube 22. Thus, the carrier plate 40 can be pivoted relative to the lower sections of the tubes 22 about a horizontal axis.

Each wheel unit 50 includes a sleeve 51, two lugs 52, a wheel 53 and a ring 54. The sleeve 51 is rotationally connected to the lower section of a corresponding tube 22 so that the sleeve 51 can rotate about the lower section of the corresponding tube 22. The lugs 52 are formed on the sleeve 51. The wheel 53 is supported on the lugs 52. The ring 54 is non-movably connected to the lower section of the corresponding tube 22. A connector unit (not shown) is used to connect each wheel unit 50 to the carrier plate 40 so that pivoting of the carrier plate 40 causes pivoting of each wheel unit 50. Details of such a connector unit can be found in U.S. Pat. No. 8,602,444 and will not be given hereinafter.

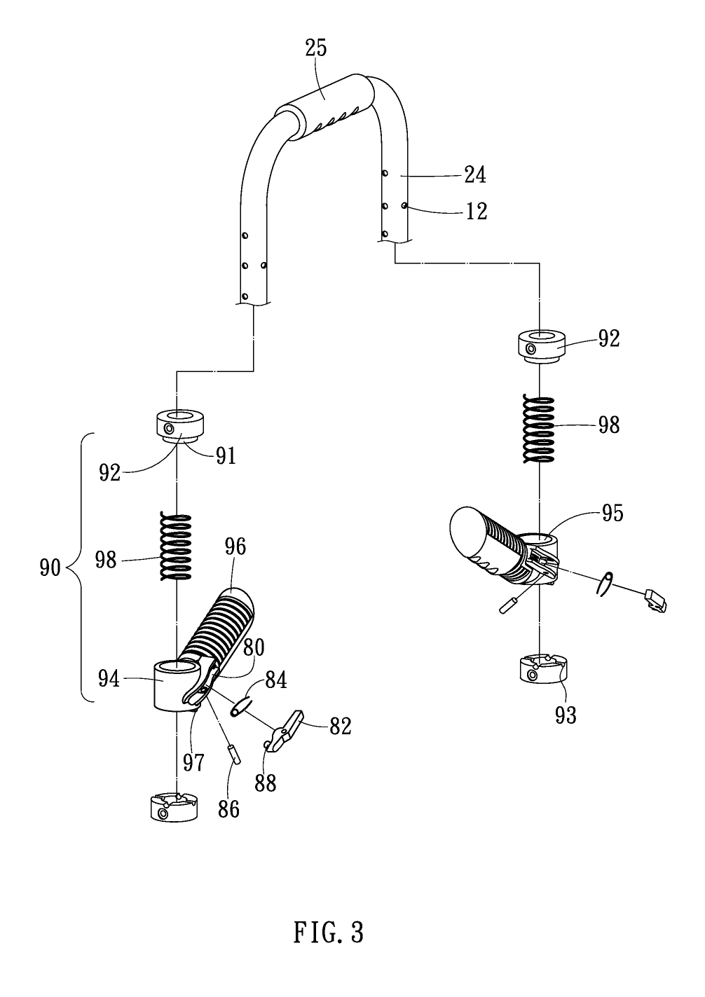

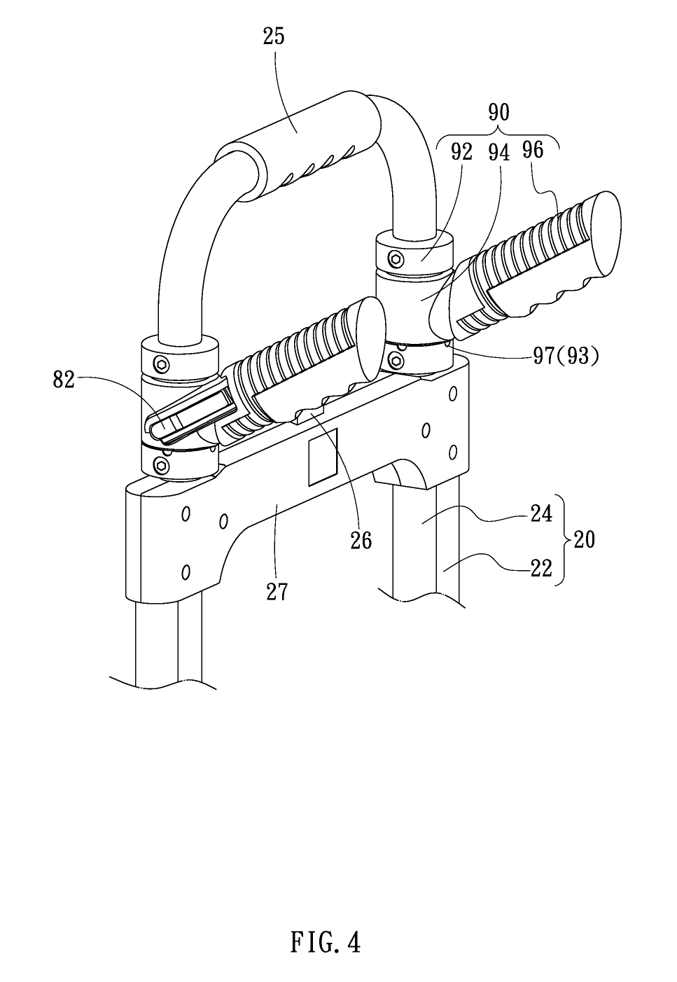

Referring to FIGS. 3 to 6, each auxiliary grip unit 90 includes two rings 92, a sleeve 94, a grip 96 and a spring 98. For the convenience of the description, one of the rings 92 will be referred to as the “upper ring 92” and the other ring 92 will be referred to as the “lower ring 92.” A lower face of the upper ring 92 is formed with an annular rib 91. Four recesses 93 are made in an upper face of the lower ring 92. The sleeve 94 includes an axial space 95 made therein and a boss 97 formed on a lower face thereof. The grip 96 is formed on the sleeve 94.

The upper and lower rings 92 are non-movably supported on the corresponding tube 24. The sleeve 94 is rotationally supported on the corresponding tube 24. The sleeve 94 is located between and restrained by and the upper and lower rings 92. The annular rib 91 of the upper ring 92 is inserted in the axial space 95 of the sleeve 94. The spring 98 is compressed between the upper ring 92 and the sleeve 94 to push the sleeve 94 towards the lower ring 92.

A locking unit (not numbered) is used to lock each grip unit 90 to the corresponding tube 24. Each locking unit includes two fins 80, a latch 82, a spring 84 and a pin 86. The fins 80 are formed on the sleeve 94 or the grip 96 of the corresponding grip unit 90. The latch 82 is formed with a transverse insert 88. The latch 82 is located between the fins 80. The pin 86 is used to pivotally connect the latch 82 to the fins 80. The spring 84 is located between the latch 82 and the sleeve 94 or the grip 96. The spring 84 is preferably a torque spring formed with a helical section and two rectilinear sections. The pin 86 is inserted in the helical section of the spring 84 to retain the spring 84 in position.

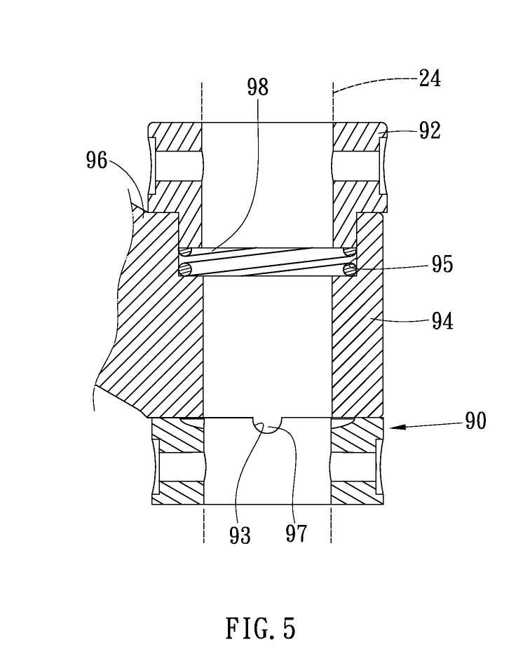

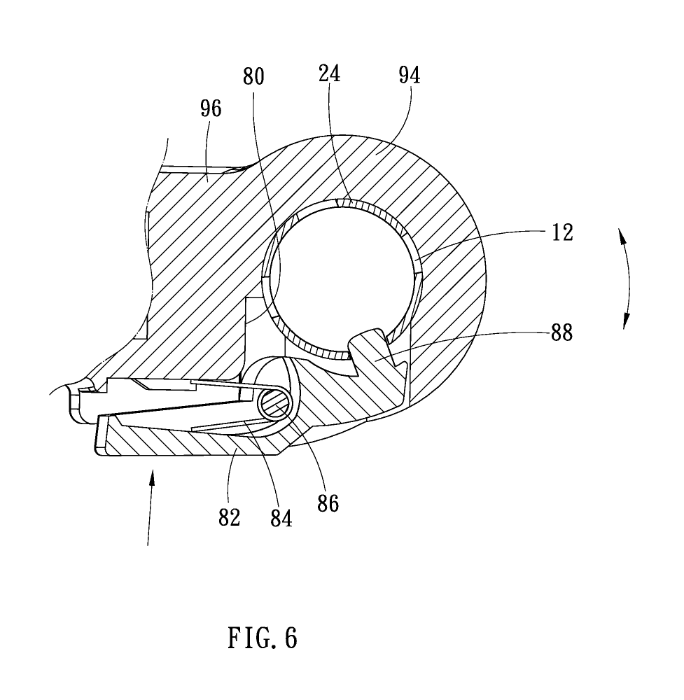

Referring to FIGS. 5 and 6, a locking unit is located in the locking position. The insert 88 is inserted in one of four bores 12 made in the corresponding tube 24. Accordingly, the boss 97 is inserted in one of the recesses 93. Thus, the locking unit locks the corresponding auxiliary grip unit 90 in one of four positions relative to the corresponding tube 24.

Although not shown, the latch 82 can be pivoted to turn the locking unit into the releasing position. In the releasing position, the insert 88 is located out of any of the bores 12. Accordingly, the insert 88 can be rotated relative to the corresponding tube 24. The boss 97 can be moved out of any of the recesses 93, with the spring 95 loaded. Thus, the locking unit allows the corresponding auxiliary grip unit 90 to rotate into another one of the positions relative to the corresponding tube 24.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A collapsible trolley including:
a frame including two lower tubes and two upper tubes each pivotally connected to a corresponding one of the lower tubes;
a carrier plate connected to the lower tubes;
two wheel units each connected to a corresponding one of the lower tubes;
a primary grip supported on the upper tubes; and
two auxiliary grip units each pivotally connected to a corresponding one of the upper tubes.

2. The collapsible trolley according to claim 1, wherein each of the auxiliary grip units includes:
a sleeve supported on the corresponding upper tube; and
an auxiliary grip supported on the sleeve.

3. The collapsible trolley according to claim 2, wherein each of the auxiliary grip units includes first and second rings non-movably supported on the corresponding upper tube, wherein the sleeve is located between the first and second rings.

4. The collapsible trolley according to claim 3, wherein the first ring includes an annular rib rotationally inserted in the sleeve.

5. The collapsible trolley according to claim 3, wherein the second ring includes recesses, wherein the sleeve includes a boss for insertion in a selected one of the recesses to keep the sleeve and therefore the auxiliary grip in a selected position corresponding to the selected recess.

6. The collapsible trolley according to claim 5, wherein each of the auxiliary grip units includes a spring compressed between the first ring and the sleeve to push the sleeve towards the second ring.

7. The collapsible trolley according to claim 5, further including two locking units each for locking a corresponding one of the auxiliary grip units in the selected position on the corresponding upper tube.

8. The collapsible trolley according to claim 7, wherein each of the upper tubes includes bores corresponding to the recesses, wherein each of the auxiliary grip units includes a latch connected to one of the sleeve and the auxiliary grip and formed with an insert for insertion in a selected one of the bores.

9. The collapsible trolley according to claim 8, wherein the latch is pivotally connected to one of the sleeve and the auxiliary grip.

10. The collapsible trolley according to claim 9, wherein each of the auxiliary grip units includes two fins formed on at least one of the sleeve and the auxiliary grip, wherein the latch is located between and pivotally supported on the fins.

11. The collapsible trolley according to claim 10, wherein each of the locking units includes a pin inserted in the fins and the latch to pivotally connect the latch to the fins.

12. The collapsible trolley according to claim 9, wherein each of the locking units includes a spring compressed between the latch and one of the sleeve and the auxiliary grip to push the insert towards the corresponding upper tube.

13. The collapsible trolley according to claim 2, further including two locking units each for locking a corresponding one of the auxiliary grip units in the selected position on the corresponding upper tube.

14. The collapsible trolley according to claim 13, wherein each of the upper tubes includes bores, wherein each of the auxiliary grip units includes a latch connected to one of the sleeve and the auxiliary grip and formed with an insert for insertion in a selected one of the bores.

15. The collapsible trolley according to claim 14, wherein the latch is pivotally connected to one of the sleeve and the auxiliary grip.

16. The collapsible trolley according to claim 15, wherein each of the auxiliary grip units includes two fins formed on at least one of the sleeve and the auxiliary grip, wherein the latch is located between and pivotally supported on the fins.

17. The collapsible trolley according to claim 16, wherein each of the locking units includes a pin inserted in the fins and the latch to pivotally connect the latch to the fins.

18. The collapsible trolley according to claim 14, wherein each of the locking units includes a spring compressed between the latch and one of the sleeve and the auxiliary grip to push the insert towards the corresponding upper tube.
